(19) United States
(12) Patent Application Publication
(10) Pub. No.: US 2010/0006006 A1
(43) Pub. Date: Jan. 14, 2010

(54) Water-Soluble Silicates and Use Thereof

(75) Inventors: Ralf Bohlander, Erkrath (DE); Thomas Albers, Duesseldorf (DE); Wolfgang Pesch, Grevenbroich (DE); Michael Langen, Hilden (DE)

Correspondence Address: FOX ROTHSCHILD LLP, 2000 MARKET STREET, PHILADELPHIA, PA, 19103, US

(73) Assignee: COGNIS IP MANAGEMENT GMBH, Duesseldorf (DE)

(21) Appl. No.: 12/500,949

(22) Filed: Jul. 10, 2009

(30) Foreign Application Priority Data
Jul. 10, 2008 (EP) 080142465.4

(51) Int. Cl. C09D 5/00; C07F 7/08

(52) U.S. Cl. 106/287.13; 556/435

(57) ABSTRACT

Modified silicates are described which are obtained by reacting a waterglass solution with alkylsilanes of the general formula R—(CH₂)ₙ—Si—(X)₃, in which X, in each case independently, is CH₃, OCH₃, OC₂H₅, OC₃H₇, OCOCH₃ or Cl, and R is a saturated or unsaturated, linear or branched or cyclic radical having at least one O and/or N atom and at least 2 carbon atoms, and n is a number between 1 and 3, at a temperature in the range of from about 20 to about 80° C. The modified silicates are suitable for the hydrophilic finishing of hard surfaces, and can be used in detergents and cleaners.

### CROSS-REFERENCE TO RELATED APPLICATIONS

Priority is claimed under 35 U.S.C. § 119 to European patent application 080142465.4, filed Jul. 10, 2008, which is incorporated herein in its entirety.

### FIELD OF THE INVENTION

The present invention relates to modified water-soluble silicates and their use in cleaners.

### BACKGROUND OF THE INVENTION

The cleaning of substrates, both hard surfaces and textiles, is of great importance both domestically and in the commercial sector. Primarily, washing and cleaning have hygienic purposes, but often there are also aesthetic reasons as well. The aesthetic reasons are of importance particularly in the case of light-permeable or smooth surfaces. For example, “dusty” glass, including windowpanes, and also surfaces made of porcelain at least partly lose their shine.

In the field of cleaners for hard surfaces, such as all-purpose cleaners, glass cleaners, dishwashing compositions and bathroom cleaners, systems are known which, besides the cleaning effect, also produce a water- and/or soil-repelling effect on the treated surface. As a rule, the known compositions comprise long-chain, organic alkylsulfonates, alkyl phosphates, alkyl carboxylates or organic polymer compounds, with organosilane compounds also sometimes being used. For this purpose, acrylate-containing polymers are often also added to cleaners, as described e.g. in WO 94/26858. Besides these, silicates can, however, also be used for this purpose. From WO 2005/097961, for example, it is known that reaction products of colloidal silica particles with surfactants are suitable for providing hard surfaces with a soil-repellant finish. Here, as a result of suitable agents, the surface becomes more hydrophilic, which is evident macroscopically from a reduced contact angle between a water drop and the wetted surface. DE 10 2004 019 022 A1 describes colloidal silica-sol for the hydrophilization of hard surfaces. German patent DE 4418846 discloses alkali silicates as granules or powders, prepared from a waterglass and a silane. U.S. Pat. No. 4,759,665 discloses blends of waterglass and siloxanes. The siloxanes thicken the waterglass solution to form a gel. WO 2004/037844 discloses aqueous compositions for self-cleaning surfaces.

However, there is a need for further improved compositions for hydrophilic surface finishing. In this connection, the effectiveness of the finishing should naturally be improved, which specifically means that the contact angle between water and surface is further reduced and the finishing also lasts as long as possible.

It has now been found that certain modified soluble silicates satisfy the requirements given above.

### DETAILED DESCRIPTION OF PREFERRED EMBODIMENTS

One object of the present application is therefore directed to modified silicates which are obtained by reacting

(a) an aqueous solution of silicates which conform to the general formula M₂O.nSiO₂, where M is a cation from the group Li⁺, Na⁺, K⁺, NY₄⁺, where Y is an H atom and/or an alkyl or alkenyl group having 1 to 10 carbon atoms, with
(b) at least one organosilicon compound of the general formula (I) R—(CH₂)ₙ—Si—(X)₃ (I) in which X, in each case independently of the others, is CH₃, OCH₃, OC₂H₅, OC₃H₇, OCOCH₃ or Cl, and R is a saturated or unsaturated, linear or branched or cyclic group having at least one O and/or N atom and at least 2 carbon atoms, and n is a number between 1 and 3, at a temperature in the range of from about 5 to about 100° C.

Here, in particular the so-called waterglasses are suitable as component (a). Waterglasses are glassy, water-soluble alkali metal silicates (thus salts of silicic acids) solidified from the melt flow or their viscous aqueous solutions. In the waterglass there are typically 1-4 mol of SiO₂ per 1 mol of alkali metal oxide (M₂O), for which reason e.g. sodium waterglass and potassium waterglass are usually also characterized by the SiO₂/alkali metal oxide mass ratio or molar ratio and also the density of the aqueous solution. They contain oligomeric silicate anions with alkali metal as counterion (where e.g. M=K or Na). Particularly preferred waterglasses as reaction component (a) are sodium or potassium waterglasses. Here, preference is given to those waterglasses whose molar ratio of SiO₂:M₂O is in the range from about 2 to about 5 and is preferably in the range from about 2.5 to about 3.5. Very particular preference is given to the range from about 2.7 to about 3.4. The waterglasses are preferably used as aqueous solutions which comprise about 15 to about 50% by weight of solids (dissolved), with solutions having contents of from about 25 to about 40% by weight being particularly preferred.

Component (b) is likewise a known organosilicon compound. These preferably include the silanes. The term “silanes” is defined for the purposes of the present application to be a collective name for silicon-hydrogen compounds.

Within the context of the present invention, the soluble silicates of reaction component (a) are, however, only modified with those silanes which conform to the general formula (i):

R—(CH₂)ₙ—Si—(X)₃ (i)

in which X, in each case independently of the others, is CH₃, OCH₃, OC₂H₅, OC₃H₇, OCOCH₃ or Cl, and R is a saturated or unsaturated, linear or branched or cyclic group having at least one O and/or N atom and at least 2 carbon atoms, and n is a number between 1 and 3. Preference is given here in particular to those silanes which conform to the general formula (ii): R—(CH₂)ₙ—Si—(CH₃) (X)₂ where X and n have the meaning given above.

Suitable silanes are e.g. tris(trimethoxy)silane, octyltriethoxysilane, methyltriethoxysilanes, methyl-trimethoxysilanes; isocyanatesilane, such as tris[3-(trimethoxysilyl)propyl]isocyanurate; gamma-mercaptopropyltrimethoxysilane, bis(3-[triethoxysilyl]proply)polysulfide, beta(3,4-epoxycyclohexyl)ethyltrimethoxysilane; epoxysilanes, glycidoxy- and/or glycidoxy-propyltrimethoxysilane, gamma-glycidoxypropylmethyl-diethoxysilane, (3-glycidoxypropyl)trimethoxysilane, (3-glycidoxypropyl)hexyltrimethoxysilane, beta(3,4-epoxycyclohexyl)ethyltriethoxysilane; silanes which contain vinyl groups, such as vinyltriethoxysilane, vinyltrimethoxysilane, vinyltris (2-methoxyethoxy) silane, vinylmethyldimethoxy-silane, vinyltriisopropoxysilane; gamma-methacryloxy-propyltrimethoxysilane, gamma-methacryloxypropyl-triisopropoxysilane, gamma-methacryloxypropyltriethoxy-silane, octyltrimethyloxysilane, ethyltrimethoxysilane, propyltriethoxysilane, phenyltrimethoxysilane, 3-mercaptopropyltriethoxysilane, cyclohexyltrimethoxy-silane, cyclohexyltriethoxysilane, dimethyldimethoxy-silane, 3-chloropropyltriethoxysilane, 3-methacryloxy-propyltrimethoxysilane, isobutyltriethoxysilane, trimethylethoxysilane, phenyldimethylethoxysilane, hexamethyldisiloxane, trimethylsilylchloride, vinyl-triethoxysilane, hexamethyldisilizane, and mixtures thereof. U.S. Pat. No. 4,927,749, which is incorporated herein by reference, discloses, in Table 2, in columns 9, line 10 to column 11, line 23, further suitable silanes which can also be used within the context of the present technical teaching. Particularly preferred silanes within the context of the present technical teaching are selected from the group of alkylalkoxysilanes, preferably the trialkoxysilanes, with methyl, ethyl, propyl and/or butyl radicals. Furthermore to be mentioned as preferred are those trialkoxysilanes whose alkyl chain is interrupted by heteroatoms such as O or N. Preferred silanes are N-(2-aminoethyl)-3-aminopropylsilane, 3-aminopropyltriethoxysilane, 3-glycidyloxypropyltrimethoxysilane, 3-glycidyloxypropyltriethoxysilane and mixtures thereof. The organosilicon compounds can in each case be used as pure compounds or as a mixture, and/or also their partial hydrolysates with possible prior reduction of the alcohol liberated in the process.

The modified silicates which are subject matter of the claimed teaching can be prepared, for example, by reacting the component (a) and (b), either at room temperature (about 20° C.), or if necessary at elevated temperatures up to about 80° C., where a temperature in the range from about 20 to about 60° C. may be particularly preferred. The selection of the suitable reaction temperature is dependent on the reactivity of the silane component. Triethoxysilanes, for example, react preferably at elevated temperatures of about 40° C. and higher, where a temperature in the range from about 60 to about 80° C. may be particularly preferred. The reactants are stirred, during which it may be advantageous to add water, depending on the viscosity of the mixtures.

Preferably, the waterglass solution is initially introduced, and then the silane component (b) is added.

U.S. Pat. No. 4,927,749 discloses reaction products of colloidal silicates with silanes and their use for separating blood cells. In this connection, the modified silicates of the teaching according to U.S. Pat. No. 4,927,749 differ from the silicates according to the invention in particular in that the latter use water-soluble waterglasses as the silicate base whereas in the US specification the structurally different colloidal silicate dispersions are used.

Preferably, the reaction product from a) and b) has a weight ratio of the SiO₂ from (a) to the SiO₂ from (b) in the range from about 30 to about 2. Particular preference is given to a ratio of about 20:5. The ratio about 12:6 is very particularly preferred here. The average molecular weight (measured by osmometry in dilute aqueous solutions) is preferably about 150 to about 800 and in particular in the range from about 350 to about 650. The oligomeric anions of the modified silicates preferably have a particle size in the range from about 75 to about 100 nm.

A further subject matter of the present application relates to aqueous compositions comprising modified silicates according to the above description, where these compositions can comprise the modified silicates in amounts (in each case always active substance and based on the total weight of the compositions) of from about 0.01 to about 90% by weight. Preferred and selected here are first compositions which comprise the silicates in amounts of more than about 10 to about 90% by weight, preferably from about 25 to about 80% by weight and in particular from about 35 to about 75% by weight. However, these compositions can also be used in diluted form with water, e.g. as additives for detergents and preferably cleaners.

Aqueous compositions which comprise the silicates according to the present invention in amounts of from about 0.1 to about 10% by weight and in particular in amounts of from about 0.5 to about 6% by weight and in particular from about 1 to about 4% by weight are therefore likewise preferred.

The modified silicates according to the above description can either be used alone or in combination with surfactants in order to give hard surfaces (plastic, ceramic, metal, wood or glass) a hydrophilic finish and/or to impart shine to these surfaces. The hydrophilic finishing leads e.g. to a reduction in the contact angle between a water drop and the wetted surface. The surfaces finished in this way then allow applied water to run off more rapidly which, as a result, leads to a reduction of deposits (especially Ca salts or surfactant residues) on the surfaces. This property is required especially in the case of dishwashing compositions, but can also be used advantageously for bathroom and kitchen cleaners.

Suitable surfactants, which are preferably used together with the modified silicates, are anionic, cationic, amphoteric or nonionic surfactants. The nonionic surfactants are preferred here.

Typical examples of suitable nonionic surfactants are alkoxylates of alkanols, terminally capped alkoxylates of alcohols without free OH groups, alkoxylated fatty acid lower alkyl esters, amine oxides, alkylphenol polyglycol ethers, fatty acid polyglycol esters, fatty acid amide polyglycol ethers, fatty amine polyglycol ethers, alkoxylated triglycerides, mixed ethers and mixed formals, fatty acid N-alkylglucamides, protein hydrolysates (in particular wheat-based vegetable products), polyol fatty acid esters, sugar esters, sorbitan esters, and polysorbates. If the nonionic surfactants contain polyglycol ether chains, these can have a conventional homolog distribution, but preferably have a narrowed homolog distribution. Preferably, the further nonionic surfactants are selected from the group which is formed by alkoxylates of alkanols, in particular fatty alcohol polyethylene glycol/polypropylene glycol ethers (FAEO/PO) and fatty alcohol polypropylene glycol/polyethylene glycol ethers (FAPO/EO), terminally capped alkoxylates of alkanols, in particular terminally capped fatty alcohol polyethylene glycol/polypropylene glycol ethers and terminally capped fatty alcohol polypropylene glycol/polyethylene glycol ethers, and fatty acid lower alkyl esters and amine oxides. Furthermore, the use of alkyl and/or alkenyl oligoglycosides may be preferred.

Preferred substances for the use according to the invention are nonionic surfactants selected from the classes a) to i):

The substances of class a) are selected from compounds of the general formula (I)

R¹O[CH₂CH₂O]_{X}CH₂CH(OM)R² (I)

in which R¹ is a linear or branched alkyl and/or alkenyl radical having 4 to 22 carbon atoms, or is a radical R²—CH(OH)CH₂, R² is a linear or branched alkyl and/or alkenyl radical having 8 to 16 carbon atoms, x is a number from 40 to 80, and M is a hydrogen atom or a saturated alkyl radical having 1 to 18 carbon atoms. These are so-called hydroxy mixed ethers or derivatives thereof. Hydroxy mixed ethers (HME) conform to the broad general formula R′O[AO]ₓCH₂CH(OM)R″, in which R′ is a linear or branched alkyl and/or alkenyl radical having 4 to 22 carbon atoms, R′ is a linear or branched alkyl and/or alkenyl radical having 2 to 22 carbon atoms, x is 10 to 80 and AO symbolizes an ethylene oxide, propylene oxide or butylene oxide radical and M may be a hydrogen atom or an alkyl or alkenyl radical.

Such hydroxy mixed ethers are known in the literature and are described, for example, in the German application DE 19738866. They are prepared, for example, by reacting 1,2-epoxyalkanes (R″CHOCH₂), where R″ is an alkyl and/or alkenyl radical having 2 to 22, in particular 6 to 16, carbon atoms, with alkoxylated alcohols. Within the context of the invention, preference is given to those hydroxy mixed ethers which are derived from alkoxylates of monohydric alcohols of the formula R′—OH having 4 to 18 carbon atoms, where R′ is an aliphatic, saturated, straight-chain or branched alkyl radical, in particular having 6 to 16 carbon atoms. Examples of suitable straight-chain alcohols are 1-butanol, caproic, oenanthoic, caprylic, pelargonic, capric alcohol, 1-undecanol, lauryl alcohol, 1-tridecanol, myristyl alcohol, 1-pentadecanol, palmityl alcohol, 1-heptadecanol, stearyl alcohol, 1-nonadecanol, arachidyl alcohol, 1-heneicosanol, behenyl alcohol and technical-grade mixtures thereof, as are produced in the high-pressure hydrogenation of technical-grade methyl esters based on fats and oils. Examples of branched alcohols are so-called oxo alcohols which mostly carry 2 to 4 methyl groups as branches and are prepared by the oxo process and so-called Guerbet alcohols which are branched in the 2-position with an alkyl group. Suitable Guerbet alcohols are 2-ethylhexanol, 2-butyloctanol, 2-hexyldecanol and/or 2-octyldodecanol. The alcohols are used in the form of their alkoxylates, which are prepared by reacting the alcohols with ethylene oxide in a known manner.

In addition, other hydroxy mixed ethers are also known, namely those which have more than one free hydroxyl group in the molecule. Such compounds can be prepared, for example, by reacting diols, preferably alkylene glycols and derivatives thereof, preferably polyethylene glycols, in each case with two mol of an alkyl epoxide (R—CHOCH₂) per mole of the diol.

The likewise suitable substances of class b) are selected from the group of compounds of the formula (II)

R³O[CH₂CH₂O]_{y}[CH₂CHCH₃O]_{z}CH₂CH(OH)R⁴ (II)

in which R³ is a linear or branched alkyl and/or alkenyl radical having 8 to 22 carbon atoms, R⁴ is a linear or branched alkyl and/or alkenyl radical having 8 to 16 carbon atoms, y is a number from 10 to 35, z is zero or a number from 1 to 5, with the proviso that if R³═R¹ and at the same time R⁴═R², then z must be at least 1.

These compounds are likewise HME, although these have a different structure than the HMEs of the general formula (I). The compounds of type b) conform to the formula (II)

R³O[CH₂CH₂O]_{y}[CH₂CHCH₃O]_{z}CH₂CH(OH)R⁴ (II)

in which R³ is a linear or branched alkyl and/or alkenyl radical having 8 to 22 carbon atoms, R⁴ is a linear or branched alkyl and/or alkenyl radical having 8 to 16 carbon atoms, y is a number from 10 to 35, z is zero or must be a number from 1 to 5. It may be advantageous that if R³═R¹ and at the same time R⁴═R², those compounds of the formula b) are selected in which the index z is at least 1. Particularly preferred compounds of type b) are, for example, those in which, in the formula (II), the index y is a number from 20 to 30, preferably from 20 to 25. Furthermore, preference is given to those compounds of type b) in which, in the formula (II), R³ represents an alkyl radical having 8 to 12, preferably 8 to 10, carbon atoms, R⁴ is an alkyl radical having 10 to 12, preferably having 10 carbon atoms, y is a number from 15 to 35, preferably 20 to 30, and z is a number from 1 to 3, preferably 1.

Likewise suitable are c) ethoxylated fatty alcohols of the general formula (III)

R⁵—(OC₂H₄)—OH

in which R⁵ is linear or branched alkyl and/or alkenyl radicals having 8 to 22 carbon atoms, and z is a number from 1 to 20.

These compounds are fatty alcohol ethoxylates known per se of the general formula (III) R⁵—(OC₂H₄)_{z}—OH, in which R⁵ is linear or branched alkyl and/or alkenyl radicals having 8 to 22 carbon atoms, and z is a number from 1 to 20 and preferably from 1 to 15, and in particular from 1 to 10. Typical examples are the adducts of on average 1 to 20 mol onto caproic alcohol, caprylic alcohol, 2-ethylhexyl alcohol, capric alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol, and also technical-grade mixtures thereof which are produced, for example, in the high-pressure hydrogenation of technical-grade methyl esters based on fats and oils or aldehydes from the Roelen oxo synthesis and also as monomer fraction in the dimerization of unsaturated fatty alcohols. Preference is given to adducts of from 10 to 40 mol of ethylene oxide onto technical-grade fatty alcohols having 12 to 18 carbon atoms, such as, for example, coconut fatty alcohol, palm fatty alcohol, palm kernel fatty alcohol or preferably tallow fatty alcohol. Particularly preferred fatty alcohol ethoxylates are based on tallow alcohols ethoxylated with 2 to 10 and preferably 2 to 5 mol of ethylene oxide per mole of alcohol.

Also suitable are substances of group d) which conform to the formula

R⁶CO—(OC₂H₄)ₘ—OR⁷

where R⁶ is alkyl and/or alkenyl radicals having 7 to 21 carbon atoms and m is a number from 11 to 100, and R⁷ is a hydrogen atom or a radical CO—R⁶. These compounds are monoesters and/or preferably diesters of glycol and in particular of polyglycols and are likewise known and commercially available. They can be described by the formula R⁶CO— (OC₂H₄)ₘ—OR⁷, where R⁶ is alkyl and/or alkenyl radicals having 7 to 21 carbon atoms and m is a number from 11 to 100, and R⁷ is a hydrogen atom or a radical CO—R⁶. Here, symmetrical (R⁶═R⁷) and asymmetrical compounds (R⁶ ≠R⁷) are included. Preferably, compounds of type d) which are based on polyethylene glycols with molecular weights between 1000 and 10 000 and preferably from 1500 to 6000 and in particular from 1500 to 3000 are used in the compositions according to the invention. Diester compounds of type d) are particularly preferred. As a result of the preparation, besides the compounds of type d), polyglycols may also be present as by-products.

Also suitable are compounds of type e), namely the alkyl (oligo)glycosides of the general formula R⁸O—[G]ₚ in which R⁸ is an alkyl and/or alkenyl radical having 4 to 22 carbon atoms, G is a sugar radical having 5 or 6 carbon atoms and p is a number from 1 to 10.

These compounds are likewise known as alkyl (oligo)glycosides. Alkyl and alkenyl oligoglycosides are known nonionic surfactants which conform to the above formula R⁸O—[G]ₚ. They can be obtained by the relevant methods of preparative organic chemistry. The alkyl and/or alkenyl oligoglycosides can be derived from aldoses or ketoses having 5 or 6 carbon atoms, preferably glucose. The preferred alkyl and/or alkenyl oligoglycosides are thus alkyl and/or alkenyl oligoglucosides. The index number p in the general formula gives the degree of oligomerization (DP), i.e. the distribution of mono- and oligoglycosides and is a number between 1 and 10. Whereas p in a given compound must always be a whole number and can here assume in particular the values p=1 to 6, the value p for a specific alkyl oligoglycoside is an analytically determined calculated value which in most cases is a fraction. Preference is given to using alkyl and/or alkenyl oligoglycosides having an average degree of oligomerization p of from 1.1 to 3.0. From an applications-related point of view, preference is given to those alkyl and/or alkenyl oligoglycosides whose degree of oligomerization is less than 1.7 and is in particular between 1.2 and 1.4. The alkyl or alkenyl radical R⁸ can be derived from primary alcohols having 4 to 11, preferably 8 to 10, carbon atoms. Typical examples are butanol, caproic alcohol, caprylic alcohol, capric alcohol and undecyl alcohol and also technical-grade mixtures thereof, as are obtained, for example, during the hydrogenation of technical-grade fatty acid methyl esters or in the course of the hydrogenation of aldehydes from the Roelen oxo synthesis. Preference is given to alkyl oligoglucosides of chain length C₈-C₁₀ (DP=1 to 3) which are produced as precursor in the distillative separation of technical-grade C₈-C₁₈-coconut fatty alcohol and can be contaminated with a fraction of less than 6% by weight of C₁₂-alcohol, and also alkyl oligoglucosides based on technical-grade C_{9/11}-oxo alcohols (DP=1 to 3). The alkyl or alkenyl radical R⁸ can in addition also be derived from primary alcohols having 12 to 22, preferably 12 to 14, carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol, and technical-grade mixtures thereof which can be obtained as described above. Preference is given to alkyl oligoglucosides based on hydrogenated C_{12/14}-coconut alcohol with a DP of from 1 to 3.

Also suitable are compounds of type f), the betaines. Betaines are known surfactants which are prepared predominantly by carboxyalkylation, preferably carboxymethylation, of aminic compounds. Preferably, the starting materials are condensed with halocarboxylic acids or salts thereof, in particular with sodium chloroacetate, one mol of salt being formed per mole of betaine. In addition, the addition of unsaturated carboxylic acids, such as, for example, acrylic acid, is also possible. Examples of suitable betaines are the carboxyalkylation products of secondary and in particular tertiary amines which conform to the formula (I)

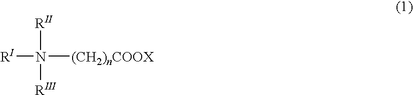

in which R¹ is alkyl and/or alkenyl radicals having 6 to 22 carbon atoms, R^{II}, is hydrogen or alkyl radicals having 1 to 4 carbon atoms, R^{III}, is alkyl radicals having 1 to 4 carbon atoms, n is a number from 1 to 6 and X is an alkali metal and/or alkaline earth metal or ammonium. Typical examples are the carboxymethylation products of hexylmethylamine, hexyldimethylamine, octyldimethylamine, decyldimethylamine, dodecylmethyl-amine, dodecyldimethylamine, dodecylethylmethylamine, C_{12/14}-cocoalkyldimethylamine, myristyldimethylamine, cetyldimethylamine, stearyldimethylamine, stearylethyl-methylamine, oleyldimethylamine, C_{16/18}-tallow-alkyl-dimethylamine and technical-grade mixtures thereof.

Furthermore suitable are also carboxyalkylation products of amidoamines which conform to the formula (2)

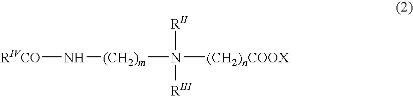

in which R^{IV}CO is an aliphatic acyl radical having 6 to 22 carbon atoms and 0 or 1 to 3 double bonds, m is a number from 1 to 3 and R^{II}, R^{III}, n and X have the meanings given above. Typical examples are reaction products of fatty acids having 6 to 22 carbon atoms, namely caproic acid, caprylic acid, capric acid, lauric acid, myristic acid, palmitic acid, palmoleic acid, stearic acid, isostearic acid, oleic acid, elaidic acid, petroselic acid, linoleic acid, linolenic acid, elaeostearic acid, arachic acid, gadoleic acid, behenic acid and erucic acid and also technical-grade mixtures thereof, with N,N-dimethylaminoethylamine, N,N-dimethylaminopropylamine, N,N-diethylaminoethyl-amine and N,N-diethylaminopropylamine, which are condensed with sodium chloroacetate. Preference is given to using a condensation product of C_{8/18}-coconut fatty acid N,N-dimethylaminopropylamide with sodium chloroacetate.

Furthermore, suitable starting materials for the betaines to be used within the context of the invention are also imidazolines which conform to the formula (3)

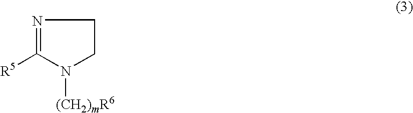

in which R^{V} is an alkyl radical having 5 to 21 carbon atoms, R⁶ is a hydroxyl group, an OCOR^{V} or NHCOR^{V} radical and m is 2 or 3. These substances are also known substances which can be obtained, for example, by cyclizing condensation of 1 or 2 mol of fatty acid with polyfunctional amines, such as, for example, aminoethylethanolamine (AEEA) or diethylenetriamine. The corresponding carboxyalkylation products are mixtures of different open-chain betaines. Typical examples are condensation products of the aforementioned fatty acids with AEEA, preferably imidazolines based on lauric acid or in turn C_{12/14}-coconut fatty acid, which are then betainized with sodium chloroacetate.

Suitable as further suitable compound class are g) compounds of the general formula (III)

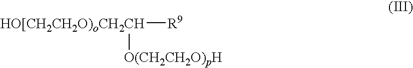

in which R⁹ is a linear or branched alkyl and/or alkenyl radical having 4 to 22 carbon atoms and o is a number from 1 to 20 and the index p is zero or a number from 1 to 20. These likewise known nonionic compounds are prepared, for example, by reacting alkyl epoxides with ethylene glycol and then with further ethylene oxide.

Then come h) compounds of the general formula (IV)

R¹⁰CH(OR¹¹)CH₂—OR¹¹ (IV)

in which R¹⁰ is a saturated or unsaturated, branched or unbranched alkyl or alkenyl radical having 8 to 16 carbon atoms, and R¹¹, in each case independently of one another, symbolize a radical (CH₂CH₂O)ᵣCH₂CH(OH)R¹² where r in each radical R¹¹ is independently zero or a number from 1 to 50, and R¹² is a saturated or unsaturated, branched or unbranched alkyl or alkenyl radical having 8 to 16 carbon atoms.

Finally, i) compounds of the general formula (V) are also suitable,

NR¹³₃ (V)

where R¹³ independently of the others, is a radical (CH₂CH₂O)ₛ—CH₂CH(OH)R¹⁴ or an alkyl radical having 8 to 16 carbon atoms and s for each individual radical R¹³ is independently zero or a number from 1 to 50.

The compositions comprising the modified silicates and the surfactants (the latter in amounts of from preferably 1 to 30% by weight, based on the total composition) are used alone, or as compound e.g. with other surfactants or fillers or other suitable additives, preferably in cleaners.

### EXAMPLES

### Preparation of the Silicate Solutions According to the Invention

### Example 1

81 parts of an aqueous potassium silicate solution (SiO₂/K₂O molar ratio 3.15; solids fraction: 41% by weight) were mixed with 12 parts of water and to this were then added dropwise at room temperature 7 parts of 3-glycidyloxypropyltrimethoxysilane. When the addition was complete, the mixture was stirred for 15 minutes more at room temperature until the clear solution according to the invention was obtained.

### Example 2

67 parts of an aqueous potassium silicate solution (SiO₂/K₂O molar ratio 2.9; solids fraction: 42% by weight) were mixed with 27 parts of water and to this was then added dropwise at room temperature 1 part of 3-aminopropyltriethoxysilane and the mixture was then heated to 60° C. 6 parts of 3-glycidyloxypropyl-trimethoxysilane were then added. When the addition was complete, the mixture was stirred for a further 50 minutes until the clear solution according to the invention was obtained.

### Example 3

77 parts of an aqueous sodium silicate solution (SiO₂/Na₂O molar ratio 3.0; solids fraction: 29% by weight) were mixed with 18 parts of water and to this were then added dropwise at room temperature 5 parts of 3-glycidyloxypropyltrimethoxysilane. When the addition was complete, the mixture was stirred for a further 15 minutes at room temperature until the clear solution according to the invention was obtained.

### Example 4

70 parts of an aqueous potassium silicate solution (SiO₂/K₂O molar ratio 3.14; solids fraction: 35% by weight) were mixed with 24 parts of water and to this were then added dropwise at room temperature 7 parts of 3-aminopropyltriethoxysilane. When the addition was complete, the mixture was stirred for a further 15 minutes at room temperature until the clear solution according to the invention was obtained.

### Example 5

81 parts of an aqueous potassium silicate solution (SiO₂/K₂O molar ratio 3.15; solids fraction: 41% by weight) were mixed with 12 parts of water and to this were then added dropwise at room temperature 7 parts of primary aminopropylsilanol (Silquest® A1106, GEAdvanced Materials). When the addition was complete, the mixture was stirred for a further 15 minutes at room temperature until the clear solution according to the invention was obtained.

Applications-related investigations:

### Contact Angle Test

The contact angles were measured on various surfaces (ceramic, glass, stainless steel) by applying a test formulation and wiping. After drying, they were rinsed with completely demineralized (DEM.) water and left to dry. On the surfaces prepared in this way the contact angle with DEM. water was measured (apparatus: contact angle measuring device from Dataphysics, Filderstadt, Model OCAH-200). Measurements were made with a solution of 1% of a fatty alcohol ethoxylate (Lutensol® ON 80, BASF) and 0.1% (active substance) of the additive from Example 1 (E1). For comparison, a solution with the commercial product Bindzil® CC30 (silica sol, Akzo; V1), and also the untreated surfaces were measured:

TABLE 1

| Surface | E1 | V1 | Untreated |
|---|---|---|---|
| Ceramic | 18.9 | 22.5 | 27.0 |
| Glass | 33.1 | 34.4 | 38.3 |
| Stainless steel | 24.6 | 46.2 | 40.1 |
| PVC | 69.0 | 75.2 | 77.8 |
| SAN¹⁾ | 73.2 | 71.8 | 78.5 |
| Polypropylene | 92.9 | 93.3 | 90.8 |

¹⁾Styrene-acrylonitrile

### Shine and Run-Off Test on Ceramic:

Firstly, a cleaned, untreated ceramic tile was measured for shine using a reflectometer. A test formulation (mixture as described above of the additive plus Lutensol® ON 80) was applied to a ceramic plate, as described above, wiped and left to dry. The resulting surface was again tested for shine and compared with the value of the original clean surface. The shine retention in percent was calculated from the values. The shine was measured using the measuring instrument Micro-TRI-Gloss from BYK Gardner at an angle of 20°. For comparison, only the Lutensol® 800N and a standard commercial silica sol (30% strength) were measured. Table 2 gives the measurement results.

TABLE 2

| | Shine | Appearance of | |
|---|---|---|---|
| Example | retention [%] | shine | Run-off behavior |
| 1 | 92.5 | shiny | complete film, film |
| | | surface, a | remains intact, flat |
| | | few wipe | film edge, rainbow |
| | | marks | effect, very slow run- |
| | | | off, after run-off |
| | | | extremely slight |
| | | | deposition on the tile |
| 2 | 90.0 | shiny | complete film, film |
| | | surface, a | remains intact, flat |
| | | few wipe | film edge, rainbow |
| | | marks | effect, after run-off |
| | | | barely visible residue |
| | | | on the tile |
| 3 | 92.4 | shiny | complete film, film |
| | | surface, a | remains intact, flat |
| | | few wipe | film edge, very slow |
| | | marks | run-off, rainbow effect, |
| | | | after run-off deposition |
| | | | on the tile |
| 4 | 92.3 | shiny | complete film, film |
| | | surface, matt | remains intact, flat |
| | | wipe marks | film edge, rainbow |
| | | | effect, after run-off |
| | | | barely visible residue |
| | | | on the tile |
| 5 | 90.9 | shiny | complete film, film |
| | | surface, matt | remains intact, flat |
| | | wipe marks | film edge, slight |
| | | | rainbow effect, after |
| | | | run-off residue on the |
| | | | tile |
| Lutensol | 79.0 | matt surface | film breaks, after run- |
| 80 ON | | with wipe | off residues on the tile |
| | | marks | |
| Kewasil | 85.6 | shiny | complete film, film |
| | | surface, matt | remains intact, flat |
| | | wipe marks, | film edge, rainbow |
| | | drop points | effect, film slightly |
| | | difficult to | breaks firstly at the |
| | | discern | upper and lower film |
| | | | edge, then film breaks |
| | | | further |

In a further test, standard commercial cleaner formulations (a bathroom cleaner, an all-purpose cleaner and a degreasing composition) were provided with additives and a shine test was carried out. The additives used were:

E1: modified silicates from Example 1, in amounts of 0.1% by weight of AS
V1: the comparison product Bindizil® CC30
V2: potassium waterglass modulus 3.14 (0.1% by weight)

The results of the shine test are given in Table 3:

TABLE 3

| | | Shine | Shine |
|---|---|---|---|
| | Shine | retention [%] | retention [%] |
| | retention [%] | All-purpose | Degreasing |
| Example | Bath cleaner | cleaner | composition |
| E1 | 90 | 66 | 79 |
| V1 | 85 | 60 | 77 |
| V2 | 80 | 62 | 71 |

What is claimed is:

1. A method for the hydrophilization of a surface comprising contacting said surface with a modified silicate prepared by a process comprising: reacting
(a) an aqueous solution of silicates which conform to the general formula M₂O.nSiO₂, where M is a cation selected from the group consisting of Li⁺, Na⁺, K⁺ and NY₄⁺, wherein Y is an H atom and/or an alkyl or alkenyl group having 1 to 22 carbon atoms, with
(b) at least one silane of the general formula (i)
R—(CH₂)ₙ—Si—(X)₃ (i)
in which X, independently is CH₃, OCH₃, OC₂H₅, OC₃H₇, OCOCH₃ or Cl, and R is a saturated or unsaturated, linear or branched or cyclic group having at least one 0 and/or N atom and at least 2 carbon atoms, and n is a number between 1 and 3,
at a temperature in the range of from about 5 to about 100° C.

2. A method for the hydrophilization of a surface comprising contacting said surface with an aqueous modified silicate composition, wherein said modified silicate is prepared by a process comprising: reacting
(a) an aqueous solution of silicates which conform to the general formula M₂O.nSiO₂, where M is a cation selected from the group consisting of Li⁺, Na⁺, K⁺ and NY₄⁺, wherein Y is an H atom and/or an alkyl or alkenyl group having 1 to 22 carbon atoms, with
(b) at least one silane of the general formula (i)
R—(CH₂)ₙ—Si—(X)₃ (i)
in which X, independently is CH₃, OCH₃, OC₂H₅, OC₃H₇, OCOCH₃ or Cl, and R is a saturated or unsaturated, linear or branched or cyclic group having at least one 0 and/or N atom and at least 2 carbon atoms, and n is a number between 1 and 3,
at a temperature in the range of from about 5 to about 100° C.,
and wherein said aqueous modified silicate composition comprises about 10 to about 90% by weight of said modified silicate, based on the total weight of the composition.

3. The method of claim 1 wherein said surface is selected from the group consisting of plastic, ceramic, metal, wood and glass.

4. The method of claim 2 wherein said surface is selected from the group consisting of plastic, ceramic, metal, wood and glass.
